(19) United States
(12) Patent Application Publication
(10) Pub. No.: US 2025/0167479 A1
(43) Pub. Date: May 22, 2025

(54) ELECTRICAL CONNECTOR WITH A DUAL-PURPOSE TERMINAL LOCK

(71) Applicant: Aptiv Technologies AG, Schaffhausen (CH)

(72) Inventors: John SCHNEIDER, Warren, OH (US); John MORELLO, Warren, OH (US)

(21) Appl. No.: 18/512,441

(22) Filed: Nov. 17, 2023

(51) Int. Cl. H01R 13/436

(52) U.S. Cl. CPC H01R 13/4367; H01R 2201/26

(57) ABSTRACT

An electrical connector that supports electrical connections of different types is described. The electrical connector includes a terminal support unit that includes an aperture array and is configured to support a terminal module seated in the terminal support unit. The terminal module supports at least one terminal that requires strict relative positioning, such as a high-speed data terminal. The electrical connector includes a terminal lock that interfaces with the terminal support unit to stabilize and lock a terminal array thought the aperture array, and to lock the terminal module in a mating position.

### BACKGROUND

Electrical connectors are commonly used in many commercial, industrial, and military applications to implement electrical systems, power, signal, computing, and communications systems. In some applications, for example vehicular applications, it may be desirable for an electrical connector to support the coupling of many electrical conductors of a vehicle wiring harness in a single connector or connection system to reduce a cost or complexity associated with installing an electrical system or systems in the vehicle.

In recent years, vehicles have been designed to support applications that require the transfer of high-speed data, such as communications and computing systems. In some examples, implementing high-speed data cable connections along with traditional automotive interconnects represents unique challenges in the design, manufacture, and installation of vehicle electrical systems. In some examples, connections of high-speed data cables such as coaxial cables, or twisted-pair cables that are used in automotive Ethernet applications have stringent coupling standards that require an interface between male and female terminals to be carefully controlled. One example of a high-speed data cable connection is Aptiv's AMEC and AMEC+ethernet connection system.

A need exists for improvements in electrical connectors that support simultaneous electrical connection of many conductors, including conductors of different types such as high-speed data conductors, in a single connector. A further need exists for connectors that are easy to manufacture and/or install in a vehicle, and that are resilient to intended decoupling during vehicle manufacture, transport, or use.

### SUMMARY

Improvements in electrical connectors that support coupling of electrical terminals of different types are described. According to one example, an electrical connector is described that includes a terminal support unit that includes an array of terminal apertures configured to receive a plurality of terminals. The connector further includes a terminal module configured to be seated in the terminal support unit adjacent to the array of terminal apertures and configured to carry at least one terminal. The connector further includes a terminal lock configured to be inserted into a track defined in the terminal support unit to lock the plurality of terminals in a mating position in the array of terminal apertures. The terminal lock also interfaces with the terminal module to lock the terminal module in a mating position seated in the terminal support unit.

According to another example, a method is described. The method includes supporting, with a terminal support unit that includes an array of terminal apertures, a plurality of terminals through the array of terminal apertures. The method further includes seating a terminal module in the terminal support unit adjacent to the array of terminal apertures, wherein the terminal module carries at least one terminal. The method further includes inserting a terminal lock into a track defined in the terminal support unit to lock the first plurality of terminals in a mating position in the first array of terminal apertures and to interface with the terminal module to lock the terminal module in a mating position in the terminal support unit.

According to another example, a terminal lock is described. The terminal lock includes a plurality of terminal apertures that include contact surfaces configured to engage terminals of a terminal array inserted through the apertures. The terminal lock further includes a pair of localization arms including positioning ends that engage with one or more recesses in a track to define a position of the terminal lock. The terminal lock further includes a plurality of engagement features configured to interface with a track to guide the terminal lock into a locked position to stabilize and lock the terminal array in a mating position through the apertures, and to engage with a terminal module adjacent to the terminal lock to lock the terminal module in a mating position.

### BRIEF DESCRIPTION OF THE DRAWINGS

The present invention will now be described, by way of example with reference to the accompanying drawings, in which:

FIG. 1 depicts an isometric view of an electrical connector according to one or more embodiments.

FIG. 2 depicts an exploded view showing components of an electrical connector according to one or more embodiments.

FIG. 3 depicts a top-down view of an electrical connector according to one or more embodiments.

FIG. 4 depicts a side view of an electrical connector according to one or more embodiments.

FIG. 5 depicts a cross-sectional view of an electrical connector according to one or more embodiments.

FIG. 6 depicts a cross-sectional view of an electrical connector according to one or more embodiments.

FIG. 7A depicts top-down view of a terminal position assurance module of an electrical connector according to some embodiments.

FIG. 7B depicts an isometric view of a terminal position assurance module according to some embodiments.

FIG. 7C depicts an alternative isometric view of a terminal position assurance module according to some embodiments.

FIG. 8A depicts an isometric view of a terminal module according to some embodiments.

FIG. 8B depicts a cross-sectional view of an electrical connector according to some embodiments.

FIG. 9A depicts a top-down view of terminal support unit with a terminal lock in a staged position according to some embodiments.

FIG. 9B depicts an opposed side of a terminal support unit with a terminal lock in the staged position according to some embodiments.

FIG. 9C depicts an isometric view of a terminal support unit with a terminal lock in the staged position according to some embodiments.

FIG. 9D depicts a cross-sectional view of a terminal support unit with a terminal lock in the staged position according to some embodiments.

FIG. 10A depicts a top-down view of terminal support unit with a terminal lock in a locked position according to some embodiments.

FIG. 10B depicts an opposed side of a terminal support unit with a terminal lock in the locked position according to some embodiments.

FIG. 10C depicts an isometric view of a terminal support unit with a terminal lock in the locked position according to some embodiments.

FIG. 10D depicts a cross-sectional view of a terminal support unit with a terminal lock in the locked position according to some embodiments.

FIG. 11 is a flow diagram that shows a method of forming an electrical connector according to some embodiments.

### DETAILED DESCRIPTION

This disclosure is directed to improvements in electrical connectors configured to support reliable coupling between electrical terminals, including terminals of different types. The described connector, which includes a terminal lock configured to not only lock terminals in a mating position, but also to lock a terminal module of the connector in a mating position, may offer advantages over other known electrical connectors. For example, the described connector may be capable of carrying many diverse connectors of different types for mating simultaneously, including traditional automotive terminals as well as high-speed data terminals or other terminals with strict relative positioning requirements. In some examples, the described connector may be less costly and/or less complex to implement/install compared to traditional electrical connectors. For example, the described connector may enable complex terminal couplings that require highly precise relative positioning to be properly mated, along with more traditional array-based connections that may not have such strict coupling requirements, in the same connector. In addition, the described connector may be particularly resilient to unintended decoupling in comparison with traditional electrical connectors.

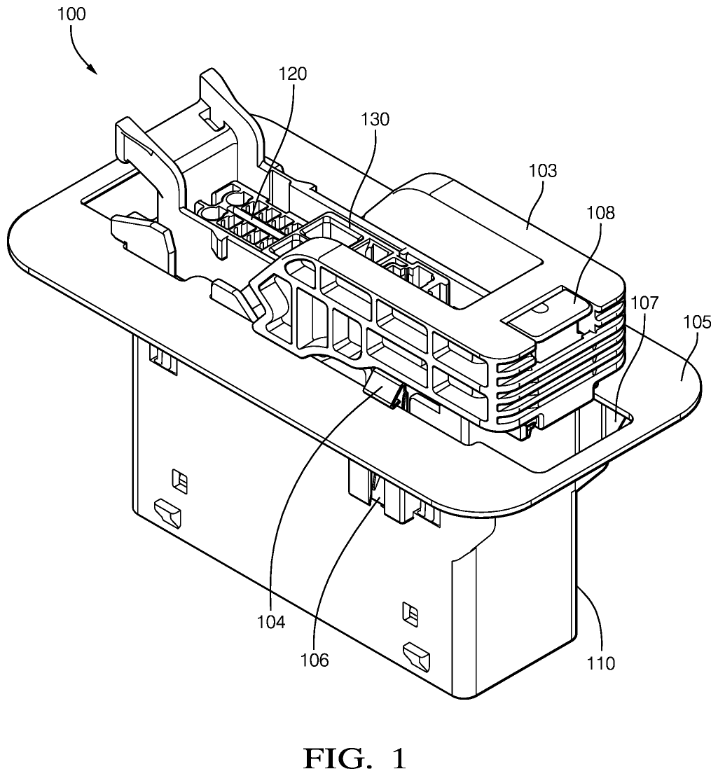

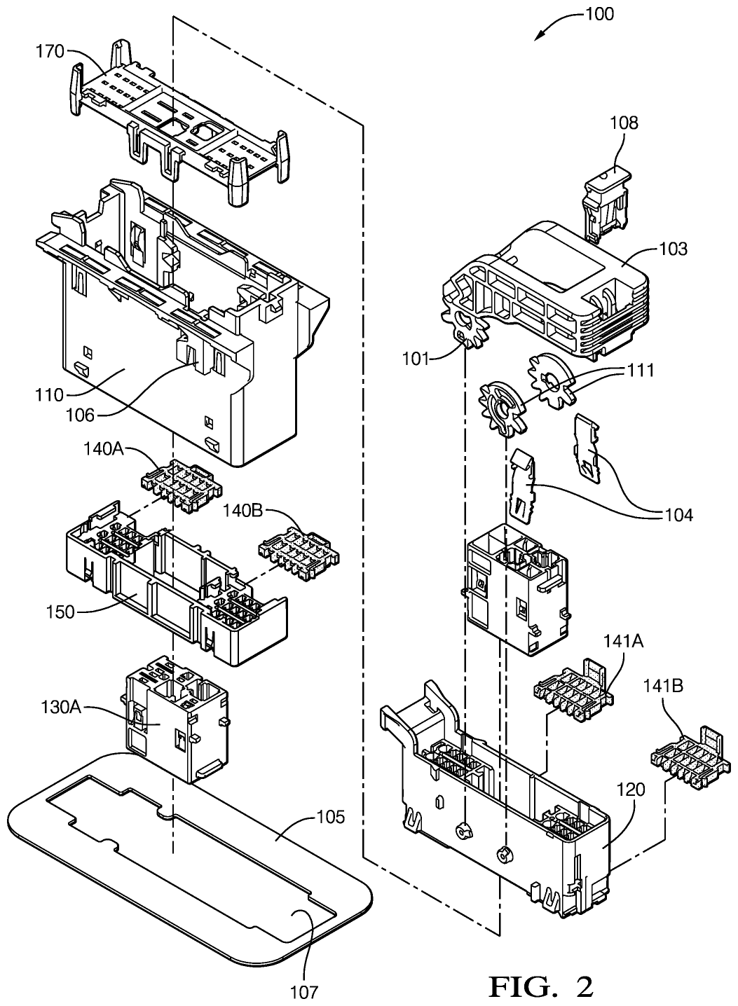

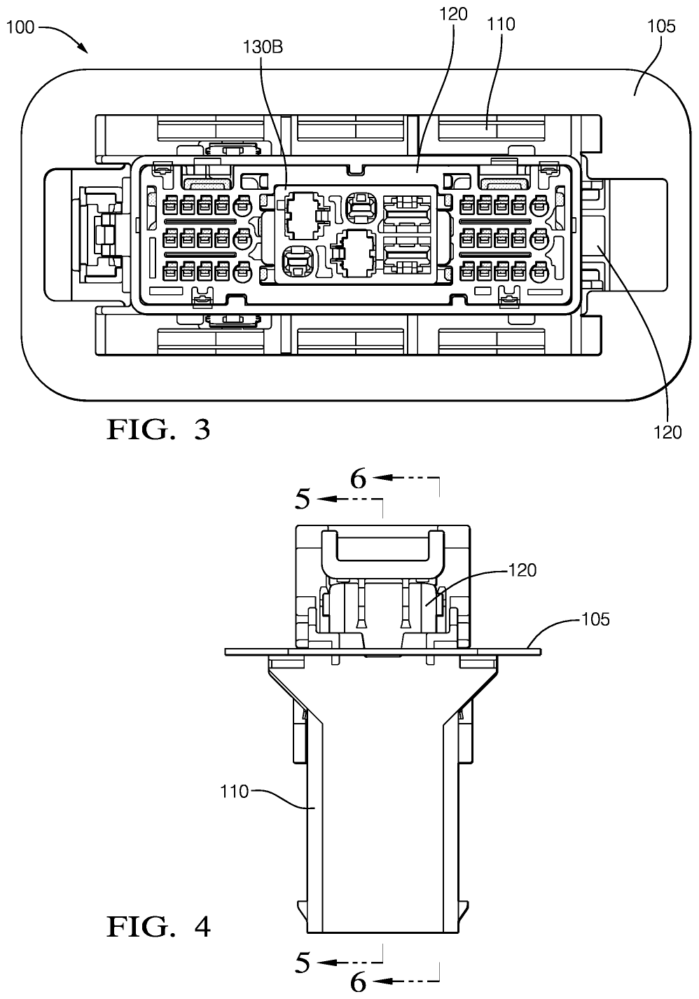

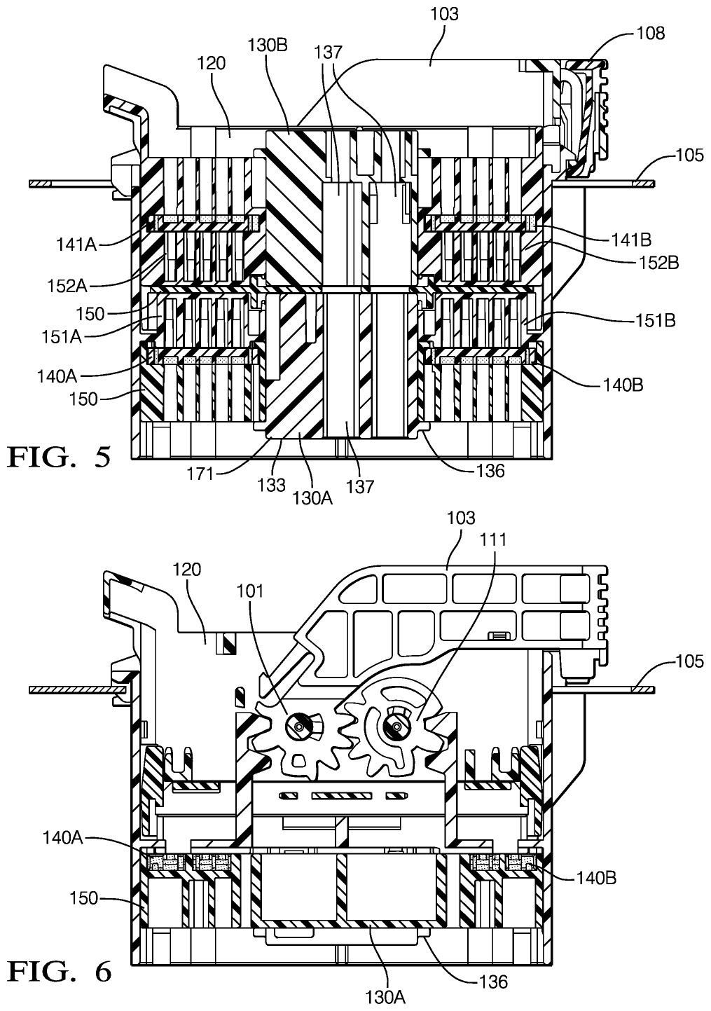

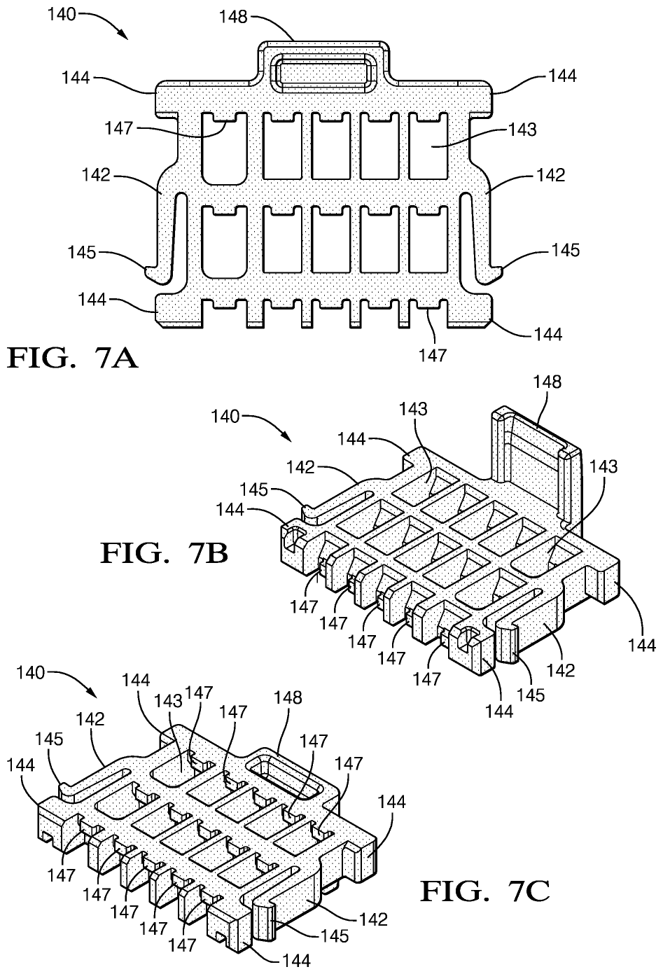

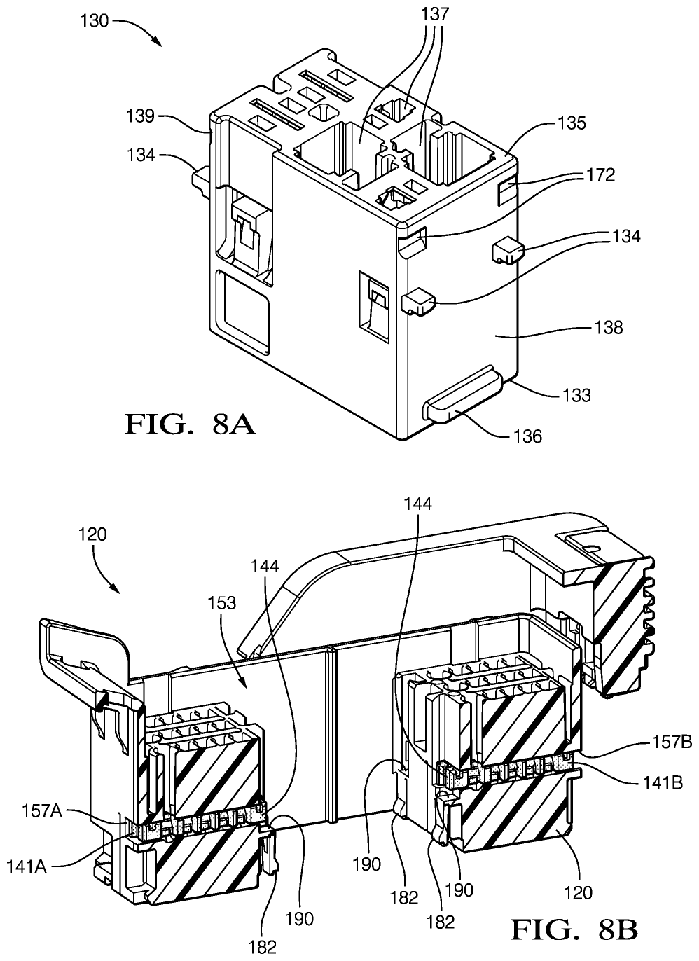

FIG. 1 is a diagram depicting an electrical connector 100 in a locked position according to some embodiments. FIG. 2 is a diagram depicting an exploded view of connector 100 according to some embodiments. FIG. 3 is a top-down view of connector 100 according to some embodiments. FIG. 4 is a side-view of connector 100 according to some embodiments. FIG. 5 is a cross-sectional view of connector 100, taken along the cut lines 5-5 depicted in FIG. 4. FIG. 6 is a cross-sectional view of connector 100, taken along the cut lines 6-6 depicted in FIG. 4, according to some embodiments.

Connector 100 is configured to receive terminals associated with a plurality of electrical conductors, for example carried by electrical cables associated with a wiring harness of a vehicle, and to enable electrical coupling of the conductors within a housing 110 of the connector 100. Connector 100 is configured to support the coupling of many electrical cables, including electrical cables of different types, within housing 110. In some examples, connector 100 may be uniquely configured to couple many traditional automotive conductors, for example conductors that carry data, signals, ground, or power for various systems associated with a vehicle, as well as to couple other types of conductors such as high-speed data conductors. For example, connector 100 may be adapted to couple coaxial and/or twisted pair cables that are configured to transfer data at very high speeds, as well as traditional automotive cables.

Referring now to FIG. 2, connector 100 includes a housing 110. Housing 110 supports a terminal support unit 150 within the housing 110, which is configured to support a first plurality of terminals (not shown) for connection therewith. Connector 100 further includes a terminal support unit 120, which is configured to support a corresponding second plurality of terminals that terminate cables of a vehicle wiring harness. The terminal support units 120, 150 are configured to be mated to one another within the housing 110 via a blade stabilizer 170 arranged between the terminal support units 120, 150. In some examples, blade stabilizer 170 stabilizes and protects terminals of connector 100 from damage. Mating the terminal support units 120, 150 together within housing 110 couples the respective first and second plurality of terminals carried by the terminal support units 150, 120, establishing a plurality of electrical connections within the housing 110.

As shown in FIG. 1, connector 100 is lockable to secure the terminal support units 120, 150 in the housing 110 and to secure the terminal connections within the housing 110. According to the example of FIG. 1, connector includes a lever 103 movable from an unlocked position (not shown) to a horizontal or locked position (shown in FIG. 1). Lever 103 interacts with gears 101 configured to interact with corresponding gears 111 (shown in FIG. 6) secured to housing 110 that define a motion of lever 110 from the unlocked position where components within the housing are accessible and removable, to a locked position that secures the internal components in position within housing 110, as shown in the cross-sectional view of FIG. 6. Connector 100 further includes a connector position assurance (CPA) 108, which is insertable into a slot defined in the lever 103 to interact with the housing 110 to lock the lever 103 in place, to prevent connector 100 from unintended decoupling. Connector 100 as depicted herein is a lever lock connector that utilizes a lever 103 to secure the connector 100, as one example of a connector locking mechanism. In other embodiments, other types of mechanisms not explicitly depicted or described herein may be used to lock connector 100.

Connector 100 may be installed in a vehicle as part of vehicle manufacturing processes. In some examples, connector 100 is arranged on a surface of the vehicle, and secured within the vehicle by straps, ties, screws, bolts, adhesives, or other fixation mechanisms. In other examples, as shown in FIGS. 1 and 2, connector 100 may be secured through an aperture 107 formed in a substrate 105 associated with the vehicle. According to such examples, housing 110 includes a plurality of slots 106 configured to receive tabs 104 that interface with substrate 105 around a perimeter of the aperture 107 to secure connector 100 in a position, for example within a vehicle. The substrate 105 may be, for example, a floor panel or wall panel of a vehicle assembly, or other structure associated with the vehicle assembly.

As noted above, connector 100 is configured to establish a plurality of electrical connections, including different types of electrical connections, for example both high-speed data connections and traditional automotive system connections, within housing 110. Referring now to FIG. 5, terminal support unit 150 includes aperture arrays 151A, 151B, and a terminal module 130A between the aperture arrays 151A, 151B. Terminal support unit 120 similarly includes aperture arrays 152A, 152B, and a terminal module 130B between the aperture arrays 152A, 152B. As shown in the example of FIG. 5, when connector 100 is locked as shown in FIG. 6, terminal support units 120, 150 are mated together within housing 110 to establish a plurality of terminal connections within connector 100, including terminals through the aperture arrays 151A, 151B, 152A, 152B as well as terminals supported by the terminal modules 130A and 130B.

As described in further detail below, connector 100 includes a plurality of terminal locks 140A, 140B and 141A, 141B that are configured to serve a dual purpose as part of an installation process of connector 100, including to stabilize terminal arrays (not shown) in a mating position of the terminal arrays, as well as to lock respective terminal modules 130A, 130B in a mating position of the terminal module 130A, 130B. In some examples, terminal locks 140A, 140B and/or 141A, 141B serve to lock modules 130A, 130B in a defined position to support coupling of electrical terminals with strict relative positioning requirements, such as high-speed data terminals like coaxial or twisted-pair high-speed data terminals.

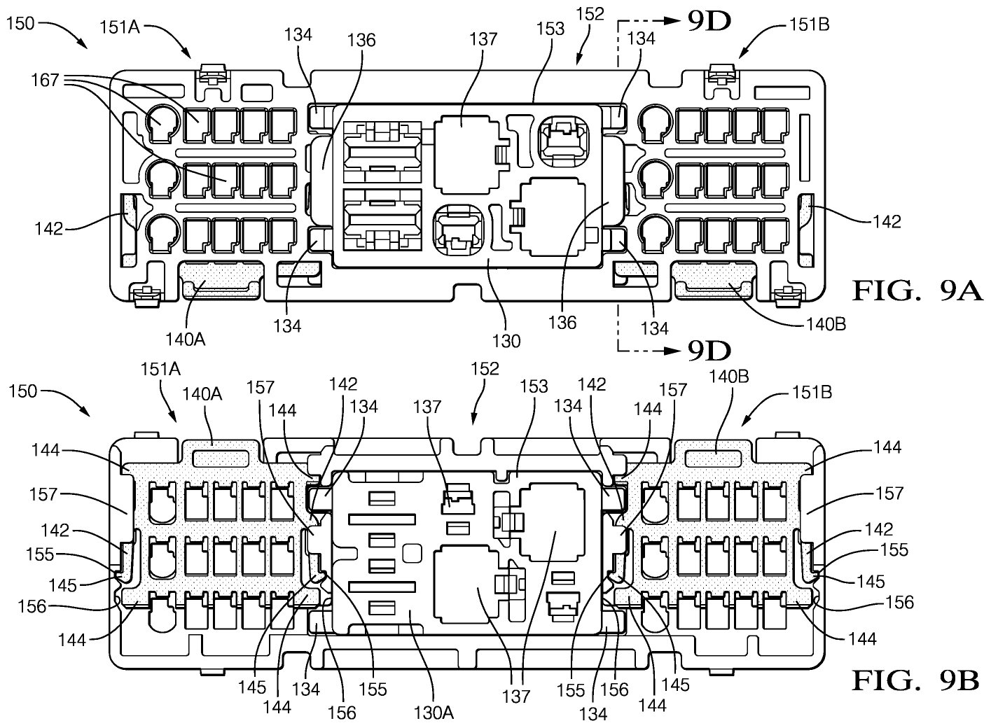

FIGS. 7A-7C depict top-down, perspective, and alternative perspective views of a terminal lock 140 according to some embodiments. Terminal lock 140 may be configured to stabilize and lock terminals of connector 100 in a mating position to be mated with corresponding terminals within connector 100.

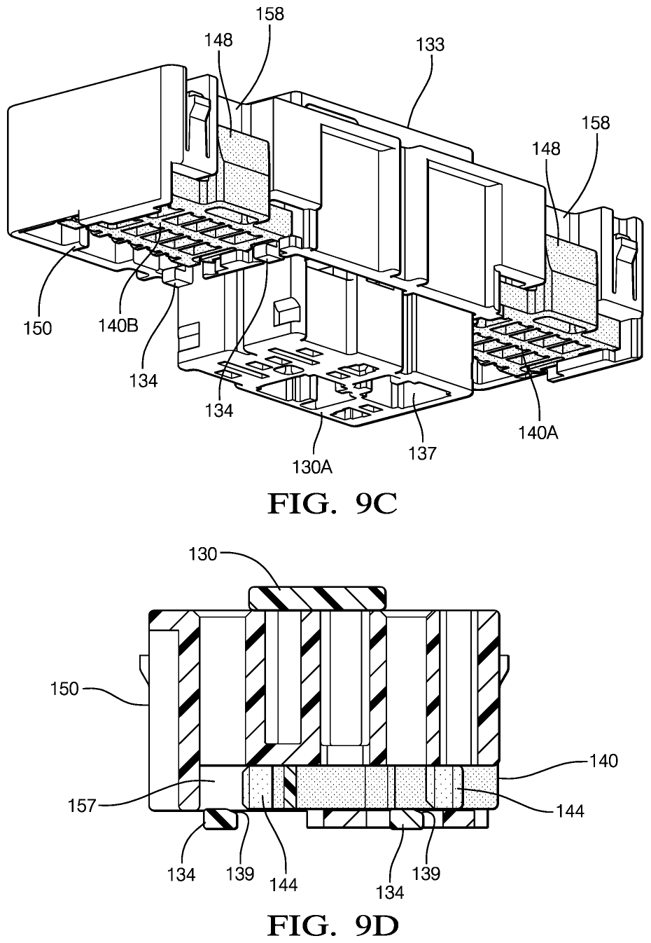

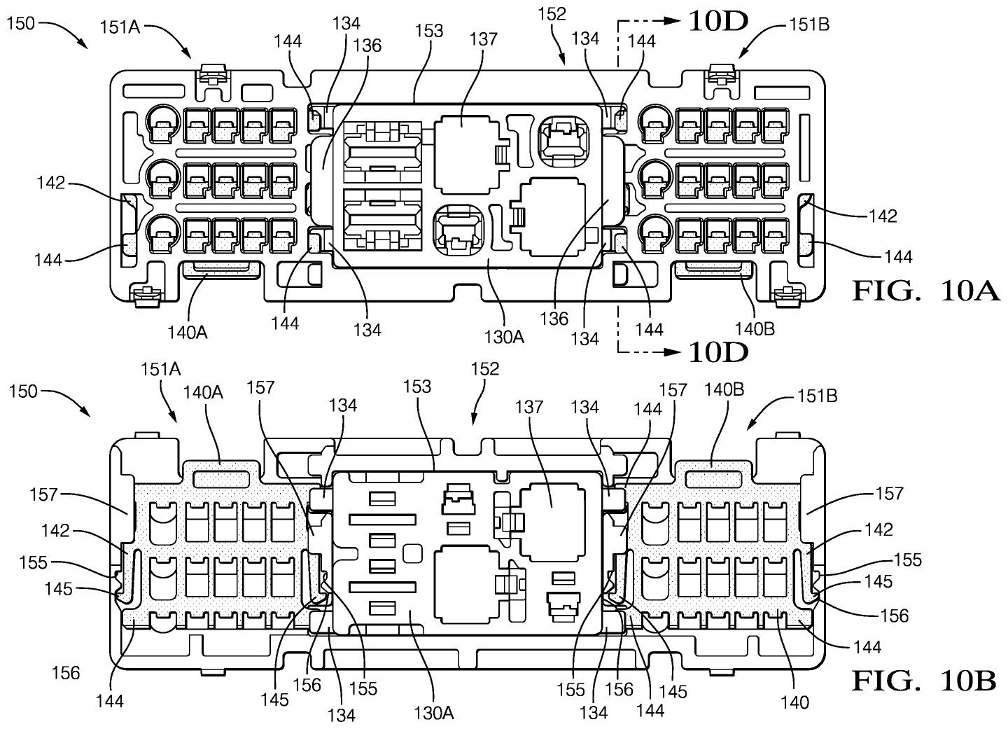

As shown in FIGS. 7A-7C, terminal lock 140 includes a plurality of terminal apertures 143 each configured to accept an electrical terminal through the aperture 143, and a plurality of contact surfaces 147 configured to contact and stabilize each terminal, locked in a mating position in the aperture 143. Terminal lock 140 further includes localization arms 142 that include positioning ends 145, and an alignment end 148 configured to interact with a corresponding channel 158 formed in a terminal support unit 150 (see FIG. 9C). Terminal lock 140 further includes locking features 144 arranged at respective corners of the terminal lock 140. As described in further detail below, locking features 144 may engage with terminal support unit 120, 150, as well as a terminal module 130 depicted in FIG. 8, to lock respective terminals of connector 100 in a mating position.

In some examples, terminal lock 140 may have an aperture pattern that corresponds to an aperture pattern of aperture arrays 151A, 151B, which may in some examples be non-uniform. For example, as shown in the example of FIG. 9A, aperture arrays 151A, 151B each include a leftmost column of apertures that is larger, and rounder, than other apertures of the aperture pattern. Referring to FIGS. 7A-7C, terminal lock 140 has an aperture pattern that corresponds to a pattern of aperture arrays 151A, 151B, and includes a leftmost column with larger apertures than other apertures of the terminal lock 140.

In some examples, referring to FIG. 2, terminal lock 140 may be used as a pair of substantially identical terminal locks 140A, 140B that operate to lock terminals in a mating position through respective aperture arrays 151A, 151B on opposed sides of a terminal module 130A, 130B as shown in FIGS. 2 and 5. According to such examples, a first pair terminal locks 140A and 140B may be substantially identical to one another (e.g., the same part) and include apertures of differing sizes to match non-uniform aperture arrays 151A, 151B.

In some examples, terminal locks 141A and 141B may similarly include aperture patterns to match non-uniform aperture arrays, and in some examples, terminal locks 141A and 141B are substantially identical (e.g., the same part) to one another. In some examples, terminal locks 141A, 141B may have an aperture pattern that is flipped relative to an aperture pattern of terminal locks 140A, 140B, such that similarly sized apertures are arranged opposed to one another when terminal locks 140A, 140B are locked and the respective terminal support units 120, 150 are mated.

FIG. 8 depicts an isometric view of a terminal module 130, which includes terminal apertures 137 on an upper surface 135 of the housing that are configured to support at least one terminal for connection therewith. The terminal module 130 may, for example, carry a high-speed data terminal or other terminal that requires a strict relative position to be properly mated.

In some examples, terminal module 130 supports connection of multiple high-speed data terminals and/or other traditional terminals as needed for a particular application. In some examples, module 130 may be interchangeable in the sense that module 130 can be swapped out to support different applications. For example, a first pair of modules 130A, 130B including terminal apertures 137 to support coupling of coaxial terminals, may be swappable in terminal support units 120, 150 with a second pair of modules 130A, 130B that include different terminal apertures 137 to support coupling of another type of high-speed data terminal, such as twisted-pair terminals. Still other modules 130A, 130B may support coupling of terminals associated with different types of coaxial cables, different types of twisted-pair cables, and/or other types of high-speed data or other cables. In this manner, connector 100 may be particularly customizable to support high-speed and other terminal connections catered to a particular vehicle application.

As shown in FIG. 8A, terminal module 130 includes a bottom surface 133 and may include ledges 136 on opposed exterior surfaces 138, 139 of module 130. Referring now to FIG. 5, surface 135 and/or ledges 136 may have a profile configured to fit within one or more of terminal support units 120, 150. For example, surface 135 and/or ledges 136 may fit in a corresponding depression 171 formed in a bottom surface of housing 110 as shown in the example of FIG. 5. In other examples not depicted, surface 135 and/or ledges may similarly interface with terminal support unit 120.

Referring again to FIG. 8A, module 130 further includes primary lock features 172 on opposed exterior surfaces 138, 139 of module 130, which are configured to engage with corresponding features of a respective terminal support unit 120, 150 to secure module 130 in a staged position within the terminal support unit 120, 150. FIG. 8B depicts one example of a terminal support unit 120 that includes primary lock features 182. Although not depicted herein, terminal support unit 150 may similarly include primary locks 182 within aperture 153.

In some examples, terminal module 130 may be inserted into aperture 153 until primary lock features 172 interact with primary locks 182, thereby securing module 130 in a staged position in terminal support unit 120. In the staged position, terminal module 130 may not be easily removed from terminal support unit 120 without disengaging primary locks 182 so that features 172 of module 130 can be moved past locks 182.

As shown in the example of FIG. 8A, module 130 further includes a plurality of locking features 134 on respective opposed surfaces 137, 139 of module 130, which may interact with corresponding features of connector 100 to lock module 130 in a mating position in connector 100. For example, when terminal module 130 is secured in a staged position by primary locks 182, locking features 134 may be arranged relative to terminal support unit 120, 150 to engage with terminal lock 140 configured to lock terminal module 130 in a mating position such that the terminal lock 140 is a secondary lock that locks the terminal module 130 in the mating position.

FIG. 9A is a top-down view of a side of a terminal support unit 150 with terminal locks 140A, 140B in a staged position according to some embodiments. FIG. 9B is a top-down view of an opposed side of terminal support unit 150 with terminal locks 140A, 140B in the staged position according to some embodiments. FIG. 9C is an isometric view of terminal support unit 150 with terminal locks 140A, 140B in the staged position, according to some embodiments. FIG. 9D is a cross-sectional view of a terminal support unit 150 with terminal locks terminal locks 140A, 140B in the staged position taken along the cut lines 9D depicted in FIG. 9A, according to some embodiments.

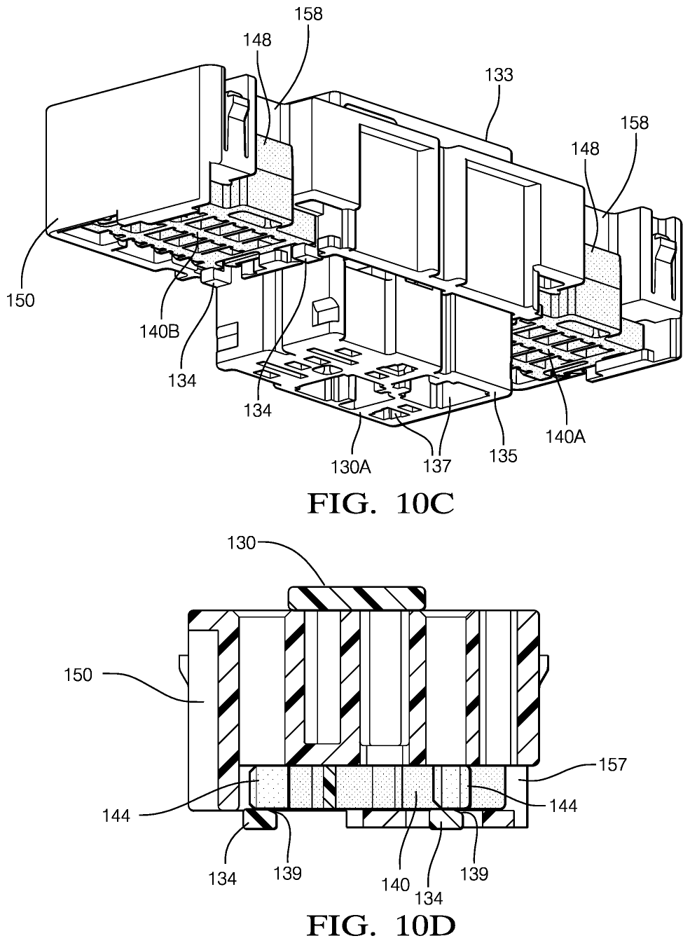

FIG. 10A is a top-down view of a side of a terminal support unit 150 with terminal locks 140A, 140B in a locked position according to some embodiments. FIG. 10B is a top-down view of an opposed side of a terminal support unit 150 with a terminal locks 140A, 140B in a locked position according to some embodiments. FIG. 10C is an isometric view of a terminal support unit 150 with terminal locks 140A, 140B in a locked position, according to some embodiments. FIG. 10D is a cross-sectional view of a terminal support unit 150 with terminal locks 140A, 140B in a locked position taken along the cut lines 10-D depicted in FIG. 10A, according to some embodiments.

As shown in FIG. 9A, terminal support unit 150 includes aperture arrays 151A, 151B. Aperture arrays 151A, 151B each include a plurality of apertures 167 configured to receive a terminal of a terminal array (not shown) for electrical connection therewith. In some examples, aperture arrays 151A, 151B may be configured to carry terminals that correspond to more traditional automotive signal conductors, such as conductors that carry lower-speed signal, data, power, or ground conductors associated with vehicle systems.

In addition to aperture arrays 151A, 151B, terminal support unit 150 further supports a terminal module 130 in the terminal support unit 150. As shown in FIG. 9A, terminal support unit 150 includes an aperture 153 sized and shaped for terminal module 130 to fit through the aperture 153 and be secured in place in a region 152 between the aperture arrays 151A, 151B. In some examples, terminal module 130, and terminal support unit 150 include primary lock features that secure terminal module 130 in a staged position in aperture 153, as described above with respect to terminal support unit 120 depicted in FIG. 8B.

Referring now to FIGS. 9A-9B, terminal module 130 may be seated in terminal support unit 150. For example, terminal module 130 may be inserted upwards into aperture 153, until primary locks 182 are engaged with primary lock features 172 as shown in the example of FIG. 8B. In some examples, in the staged position, terminal module 130 locking features 134 engage with recessed surfaces 190 adjacent tracks 157A, 157B. In some examples, in the staged position, locking features 134 extend at least partially into the adjacent tracks 157A, 157B.

Terminal locks 140A, 140B may be inserted into tracks 157A, 157B formed in terminal support unit 150 and pushed into the tracks 157A, 157B, with alignment tab 148 aligned in channel 158, until positioning ends 145 of arms 142 reach a first depression 155 in the track 156, which defines a staged position of the terminal locks 140A, 140B. Locking features 144 at respective corners of terminal lock 140A, 140B may be engaged with track 157, guiding terminal lock 140A, 140B to the staged position in the track 157. In the staged position, apertures 143 of the terminal locks 140A, 140B are aligned with aperture arrays 151A, 151B of terminal support unit 150, such that terminals of respective terminal arrays (not shown) may be inserted through the apertures 143. Referring now to FIG. 8D, in the staged position, locking features 144 are not engaged with locking features 134 of module 130.

Once respective terminal arrays (not shown) have been inserted through apertures 143, terminal locks 140A, 140B may be moved to a locked position, by pushing terminal locks 140A, 140B further into tracks 157 until positioning ends 145 interact with a second depression 156 formed in the track, which defines a locked position of the terminal lock 140A, 140B.

Referring to FIG. 10A, when moved to the locked position, contact surfaces 147 associated with each of apertures 143 of terminal lock 140A, 140B, may be brought into contact with terminals supported through the aperture 143, to lock each terminal in a mating position. In the locked position, terminal support unit 150 may be mated with a corresponding terminal support unit (e.g., 120), which itself presents corresponding second terminals locked in a mating position for electrical connection.

Referring now to FIGS. 10B and 10D, which show top-down and cross-sectional views of terminal support unit 150 with terminal locks 140A, 140B in the locked position, locking features 144 of terminal locks 140A, 140B interact with locking features 134 of module 130 to lock module 130, including one or more terminals supported by module 130, in a mating position in connector 100. Locking features 134, 144 may be specifically designed to interact with one another to tightly define a position of module 130 relative to terminal support unit 150, such that when mated with a corresponding terminal support unit (e.g., terminal support unit 120 as depicted in FIGS. 1 and 2), terminals carried by module 130 are secured at a tightly defined relative position. In some examples, locking features 134, 144 are configured to cam module 130 forward into track 157 into a tightly locked position relative to terminal support unit 150.

In some examples, as shown in FIG. 10D, locking features 134 and/or locking features 144 include one or more ramp surfaces to facilitate a tightly defined locked position of terminal module 130. For example, as shown in FIG. 10D, locking feature 134 includes ramp surfaces 139 that assist locking features 144 to travel into a tightly locked position in response to terminal lock 140A, 140B being moved from the staged position to the locked position. For example, ramp surfaces 139 may extend into track 157 and guide locking features 144 into a tightly locked position relative to locking features 134 in track 157.

Referring again to the example of FIG. 8B, when terminal module 130 is locked in a mating position by terminal locks 140A, 140B, locking features 134 may be sandwiched between recessed surfaces 190 and locking features 144, which tightly locks terminal module 130 in a mating position, with outer surface 135 secured firmly in a predetermined position for mating.

In some examples, a connector 100 as described herein may incorporate terminal arrays 151A, 151B on either side of an aperture 153 that supports a terminal module 130 in region 152 as depicted in the examples of FIGS. 9A-9D, and 10A-10D. In other examples, connector 100 may include only a single aperture array 151A, and connector 100 may include a terminal lock 140A that interacts with one side 136 of a module 130 to lock it in place, while another mechanism is used to lock an opposed side 137 of the module 130.

Referring back to the exploded view of FIG. 2, in some examples, connector 100 may incorporate a terminal support unit 120 that corresponds to and is configured to mate with terminal support unit 150 to establish a plurality of electrical connections within connector 100. According to these examples, terminal support unit 120 may incorporate aperture arrays 152A, 152B that correspond to aperture arrays 151A, 151B depicted in FIGS. 9A-9D and 10A-10D, and may further include a terminal module 130B that corresponds to module 130A carried by terminal support unit 150. According to these examples, connector 100 may be assembled by inserting module 130A through aperture 153 between the aperture arrays 151A, 151B until primary locks 182 are engaged, and inserting terminal locks 140A and 140B into tracks 157 until they reach a staged position. Respective terminal arrays (not shown) may be arranged to extend through the aperture arrays 151A, 151B. Terminal locks 140A and 140B may then be moved to a locked position, where they stabilize the terminals in a mating position, as well as lock module 130A in a mating position. In some examples, terminal locks 140A and 140B may be substantially identical. For example, each of terminal locks 140A and 140B may have a similar aperture pattern that matches a uniform or non-uniform aperture pattern of terminal arrays 151A, 151B.

Terminal support unit 120 be similarly assembled. For example, terminal module 130B may be seated in terminal support unit 120, for example between respective aperture arrays 152A, 152B of terminal support unit 120. The respective aperture arrays 152A, 152B may have an aperture pattern flipped relative to an aperture pattern of aperture arrays 151A, 151B, so that the respective terminals line up when terminal support units 120, 150 are mated. Terminal module 130B may carry terminals that terminate electrical cabling, for example electrical cabling associated with a vehicle wiring harness. Terminal locks 141A and 141B are substantially similar to terminal lock 140 depicted in FIGS. 7A-7C but with a flipped aperture pattern to correspond with aperture arrays 152A, 152B, as well as an aperture pattern opposed to terminal locks 140A and 140B. Terminal locks 141A and 141B are inserted into tracks 157 defined in terminal support unit 120 and moved to a staged position. In the staged position, respective terminal arrays (not shown) that correspond to the terminal arrays carried by terminal support unit 150 are arranged through the aperture arrays 152A, 152B. For example, the respective terminal arrays may include terminals that terminate other electrical cabling of a vehicle wiring harness. The terminal locks 141A and 141B are then moved to a locked position, in which terminals of the corresponding terminal arrays are stabilized in a mating position, which also locks corresponding module 130B in a mating position.

The respective terminal support units may be arranged in housing 110 to form a plurality of electrical connections within housing 110. For example, terminal support unit 150 may be inserted into housing 110, and locked into position in the housing 110. Blade stabilizer 170 may be arranged over terminal support unit 150, and terminal support unit 120 may be arranged over blade stabilizer 170.

Terminal support units 120, 150 may be mated together to mate corresponding terminals of the aperture arrays 151A, 151B, as well as corresponding terminals supported by terminal modules 130A and 130B. For example, connector 100 may be arranged such that when lever 103 is moved from an unlocked position to a locked position, a mating force is applied to terminal support unit 120, to mate the respective terminals and/or lock the respective terminals in place within housing 110.

In some examples, the electrical connector 100 described herein may be particularly suited to be easily installed by a human or robotic operator within a vehicle. For example, using the connector described a wiring harness may be manufactured that incorporates multiple types of electrical wires, for example some that include traditional automotive terminals, and others that include other types of cables such as high-speed data terminals. The various terminals of the wiring harness may be arranged in terminal support unit 120 and locked in a mating position as described herein, including locking a terminal support module 130B in a mating position with a terminal lock 142. Corresponding terminals may be secured within terminal support unit 150, which includes locking a terminal support module 130A in a mating position with a terminal lock 140. The wiring harness may be delivered to a vehicle manufacturer with terminal support unit 150 secured within housing 110, which may be arranged in an installation position within a vehicle, for example through an aperture 107 in a substrate 105, which may be a surface in a vehicle. The human or robotic operator may then insert terminal support unit 120 into housing 110, mating terminal support unit 120 and 150 together, and locking connector 100 via lever 103, and securing lever 103 in place by inserting CPA 108.

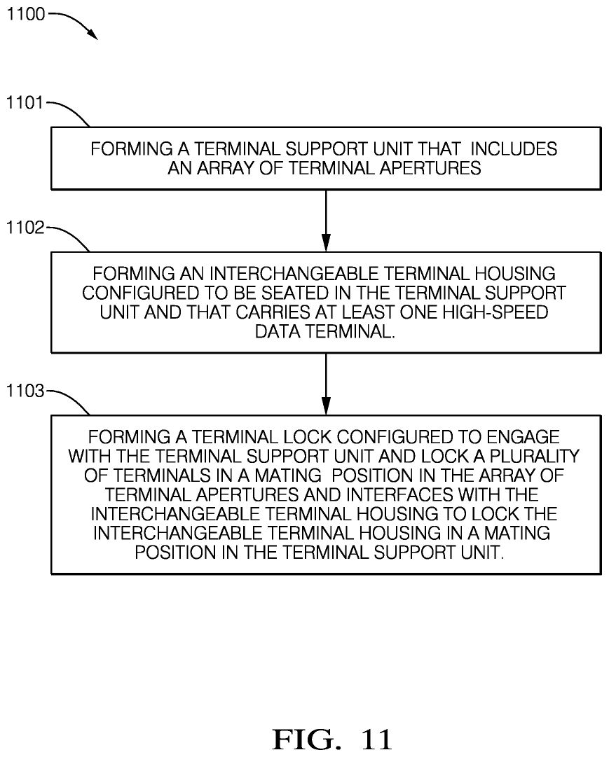

FIG. 11 is a flow diagram that depicts one example of a method 1100 of assembling an electrical connector according to some embodiments. At step 1101, the method includes seating a terminal module 130 in a terminal support unit 120, 150 of the electrical connector. In some examples, seating the terminal module in the terminal support unit 120, 150 includes engaging a primary lock 182. At step 1102, the method further includes inserting a terminal lock 140 into a track 157 defined in the terminal support unit 120, 150. For example, inserting the terminal lock 140 may include moving the terminal lock 140 to a staged position, and inserting a terminal array through an aperture array 151A, 151B of the terminal support unit 120, 150.

At step 1103, the method further includes moving the terminal lock 140 to a locked position to stabilize the terminal array in a mating position and to lock the terminal module 130 in a mating position. In some examples, the terminal support unit 120, 150 includes a plurality of aperture arrays 151A, 151B, and the terminal module 130 is arranged between the aperture arrays 151A, 151B. According to these examples, the method includes inserting respective terminal locks 140A, 140B to stabilize terminals of each aperture array 151A, 151B in a mating position such that the terminal locks 140A, 140B collectively secure the terminal module 130 in a mating position.

In some examples, inserting the terminal lock 140 includes pushing the terminal lock until the terminal lock interacts with locking features of the terminal module that extend at least partially into the track. In some examples, inserting the terminal lock 140 includes pushing the terminal lock 140 to engage with ramp surfaces 139 of the locking features 134 of the terminal module 130 to cam the terminal module 130 forward into a tightly locked mating position in the terminal support unit 150 (e.g., wedged into the end of track 157).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrical connector, comprising:
a terminal support unit that includes an array of terminal apertures configured to receive a plurality of terminals;
a terminal module configured to be seated in the terminal support unit adjacent to the array of terminal apertures and configured to carry at least one terminal; and
a terminal lock configured to be inserted into a track defined in the terminal support unit to lock the plurality of terminals in a mating position of the plurality of terminals in the array of terminal apertures, wherein the terminal lock interfaces with the terminal module to lock the terminal module in a mating position of the terminal module seated in the terminal support unit.

2. The electrical connector of claim 1, wherein the mating position of the terminal module corresponds to a strict positional tolerance of the at least one terminal carried by the terminal module.

3. The electrical connector of claim 1, wherein the terminal support unit includes a primary lock configured to secure the terminal module in a staged position in the terminal support unit; and
wherein the terminal lock is a secondary lock that locks the terminal module in the mating position of the terminal module.

4. The electrical connector of claim 1, wherein the terminal module includes locking features that extend at least partially into the track to interact with the terminal lock to lock the terminal module in the mating position of the terminal module.

5. The electrical connector of claim 1, wherein the terminal lock interacts with the terminal module to cam the terminal module tightly into the mating position of the terminal module forward in the track.

6. The electrical connector of claim 1, wherein the array of terminal apertures is a first array of terminal apertures configured to receive a first plurality of terminals, and further comprising:
a second array of terminal apertures configured to receive a second plurality of terminals, wherein the terminal module is configured to be seated in the terminal support unit between the first array of terminal apertures and the second array of terminal apertures.

7. The electrical connector of claim 6, wherein the terminal lock is a first terminal lock that interfaces with a first side of the terminal module, and further comprising a second terminal lock that locks the second plurality of terminals in a mating position of the second plurality of terminals in the second array of terminal apertures and interfaces with a second side of the terminal module, and wherein the first terminal lock and the second terminal lock operate together to lock the terminal module in the mating position of the terminal module seated in the terminal support unit.

8. The electrical connector of claim 1, wherein the terminal support unit is a first terminal support unit, and further comprising:
a second terminal support unit opposed to the first terminal support unit and configured to be mated with the first terminal support unit to form a plurality of electrical connections.

9. The electrical connector of claim 8, wherein the terminal module is a first terminal module, and wherein the terminal lock is a first terminal lock, and further comprising:
a second terminal module configured to be mated with the first terminal module and to be seated in the second terminal support unit; and
a second terminal lock configured to be inserted into a track defined in the second terminal support unit to lock the corresponding plurality of terminals in a mating position of the plurality of terminals in the corresponding array of terminal apertures, wherein the second terminal lock interfaces with the second terminal module to lock the second terminal module in a mating position of the second terminal module seated in the second terminal support unit.

10. The electrical connector of claim 9, wherein the first terminal lock is a first pair of terminal locks that lock the first terminal module in the mating position of the first terminal module seated in the first terminal support unit, and wherein the second terminal lock is a second pair of terminal locks that lock the second terminal module in the mating position of the second terminal module seated in the second terminal support unit.

11. A method, comprising:
supporting, with a terminal support unit that includes an array of terminal apertures, a plurality of terminals through the array of terminal apertures;
seating a terminal module in the terminal support unit adjacent to the array of terminal apertures, wherein the terminal module carries at least one terminal; and
inserting a terminal lock into a track defined in the terminal support unit to lock the first plurality of terminals in a mating position of the plurality of terminals in the first array of terminal apertures and to interface with the terminal module to lock the terminal module in a mating position of the terminal module in the terminal support unit.

12. The method of claim 11, wherein seating the terminal module in the terminal support unit comprises using a primary lock of the terminal support unit to secure the terminal module in a staged position.

13. The method of claim 12, wherein inserting the terminal lock comprises pushing the terminal lock until the terminal lock interacts with locking features of the terminal module that extend into the track.

14. The method of claim 13, wherein the locking features of the terminal module include ramp surfaces that cam the terminal module into a tightly locked mating position in the terminal support unit.

15. The method of claim 11, wherein the array of terminal apertures is a first array of terminal apertures supporting a first plurality of terminals, and further comprising supporting, with the terminal support unit, a second plurality of terminals through a second array of terminal apertures; and
wherein seating the terminal module in the terminal support unit comprises seating the terminal module between the first and second arrays of terminal apertures.

16. A terminal lock, comprising:
a plurality of terminal apertures, which include contact surfaces configured to engage terminals of a terminal array inserted through the apertures;
a pair of localization arms including positioning ends that engage with one or more recesses in a track to define a position of the terminal lock; and
a plurality of engagement features configured to interface with a track to guide the terminal lock into a locked position to stabilize and lock the terminal array in a mating position of the terminal array through the apertures, and to engage with a terminal module adjacent to the terminal lock to lock the terminal module in a mating position of the terminal module.

17. The terminal lock of claim 16, wherein the mating position of the terminal module corresponds to a strict relative position required to mate a terminal carried by the terminal module.

18. The terminal lock of claim 17, further comprising:
a terminal support unit that includes the track, and further comprising using a primary lock of the terminal support unit to secure the terminal module seated in the terminal support unit.

19. The terminal lock of claim 16, wherein the engagement features interface with locking features of the terminal module in the track to lock the terminal module in the mating position of the terminal module.

20. The terminal lock of claim 19, wherein the engagement features interface with ramp surfaces of the locking features in the track to lock the terminal module in the mating position of the terminal module.
